(19) United States
(12) Patent Application Publication
(10) Pub. No.: US 2008/0215374 A1
(43) Pub. Date: Sep. 4, 2008

(54) CLINICAL MANAGEMENT SYSTEM AND METHODS

(75) Inventor: Ralph C. CRAFT, New Milford, CT (US)

Correspondence Address: MICHAEL P. MORRIS;BOEHRINGER INGELHEIM USA CORPORATION, 900 RIDGEBURY ROAD, P O BOX 368, RIDGEFIELD, CT, 06877-0368, US

(73) Assignee: Boehringer Ingelheim pharmaceuticals, Inc., Ridgefield, CT (US)

(21) Appl. No.: 12/121,944

(22) Filed: May 16, 2008

Related U.S. Application Data
(63) Continuation of application No. 10/714,958, filed on Nov. 18, 2003.

(51) Int. Cl. G06Q 90/00

(52) U.S. Cl. 705/3

(57) ABSTRACT

An automated data processing method for obtaining clinical data for safety, efficacy, and adverse event assessments pertaining to a therapy prescribed for the treatment of a malady, comprising the step of receiving at a location remote from a plurality of patients outcome digital information pertaining to the outcome of therapies performed on said patients, and for the efficient delivery of medications to a patient ordered pursuant to an electronic prescription from a dispensary optimized for delivery of the medication.

### BACKGROUND

1. Field of Invention

The present invention generally relates to a health care management method and system. More specifically, the present invention describes a method and system for improving access to health care information to allow for improved management of disease states and physical injuries, and for facilitating delivery of therapies to patients in need of such therapies.

2. Discussion of Related Art

For centuries, the distribution of medicaments prescribed by a physician generally occurred by way of a pharmacy. Today, in the United States and most industrialized nations, medicaments used to treat patients are typically chosen by licensed professionals, such as physicians, who provide instructions to pharmacists to dispense medicaments to patients in a particular dosage forms with specified directions. As illustrated in FIG. 1, in this process, for example, a physician (14) writes out an order to a pharmacy (15), a so-called “prescription,” to provide a patient (17) with certain medicaments (16) along with instructions appended thereto as set forth by the physician. Typically, the patient conveys the prescription to the pharmacy, although the physician may transfer the prescription to the pharmacy by other means, such as by facsimile, email, or telephone if permitted under local regulatory laws. Thus the total process of prescribing by the doctor and the delivery by the pharmacist is generally carried out separately (that is, prescribing is reserved by the physician, while delivery is reserved for the pharmacist). The pharmacist obtains the information needed for selecting, labeling and delivering the drug from the contents of the prescription. Dispensing in a hospital setting is similar, although the prescription is generally transmitted by the physician for a patient ward, the prescription filled by the pharmacist, and the prescription transmitted back to the ward for administration by a health care professional, such as a nurse.

The current paradigm of drug distribution mirrors that of the distribution of other health care services, such as physical therapy. That is, an order is placed on paper by one health care professional trained in diagnosis and therapy, and transmitted to another health care professional for transaction upon the order. Such paradigm has significant shortcomings in that the order is simply that, an order without incorporation of all of the health information upon which the order was based. The professional filling or completing the order is deprived of information which could be very useful to the ultimate management of the patient's health. Further, feedback as to the course of the therapy is often lost from the system unless feedback is provided to the professional writing the order. For example, a physician might prescribe a medication for the treatment of colds which might be available in a sugar and a non-sugar formulation. Information as to the fact that a patient is diabetic which is not typically indicated on a prescription, would be useful for a pharmacist in selecting between the two formulations. Further information gleaned by the pharmacist with respect to the patient's recovery from the cold and medication refill history is not generally available to the physician who wrote the prescription.

Moreover, there is an ever increasing need for pharmacy services in rural areas of this country as many farm communities become depopulated and find themselves devoid of basic services that exist with municipal living, including the availability of pharmacies and drugstores. In addition to the absence of pharmacies or drugstores, there is growing need for expert medical and pharmaceutical consultation and communication on prescription and dispensation of medicine.

According to available data, total health care costs in the United States reached $1.3 trillion in 2000. This represents a per capita health care expenditure of $4,637.

Worldwide sales of pharmaceutical products alone totaled $430.3 billion in 2002 according to IMS Health, with sales in the United States representing 51 percent of the total. Over the past thirty years, the number of drug products has increased from several hundred drugs, to over ten thousand. Studies show that over two-thirds of all physician-patient encounters are completed with the writing of a prescription, with the average physician prescribing hundreds of thousands of dollars worth of drugs annually. Many patients receive more than one prescription per visit. It is estimated that over 3 billion prescriptions are filed in United States retail pharmacies alone each year, accounting for retail sales of over $100 billion. In 2000, total prescription drug expenditure in the United States was estimated to be $121.8 billion, or approximately $430 per person. Drug sales in the United States in 2003 were estimated to exceed $204 billion with total prescriptions or scripts filled close to 3.4 billion (The Pink Sheet, p. 12, Sep. 1, 2003). Continued growth in prescription volume is anticipated as the American population as a whole ages, and with the growth in managed care, and increased reliance on prescription drugs and pharmacotherapy. The Medicare Rx benefit is also estimated to add about 75 million to 100 million incremental prescriptions per year to the market (The Pink Sheet, p. 12, Sep. 1, 2003).

While most physicians exercise high skill in prescribing, and pharmacists exercise high skill in dispensing, tens of thousands of patients suffer each year due to errors made by these professionals. In fact, it is estimated in the United States that deaths due to medication errors exceeds those due to motor vehicle accidents (Cox et al., Dealing with Dispensing Errors, The Pharmaceutical Journal 264: 724 (May 2000)).

In a study of one 631-tertiary care teaching hospital over 60 months, Lear reports a total of 1,115 clinically significant prescribing errors involving medication dosage forms (Lear, T. S., Prescribing errors involving medication dosage forms, J. Gen. Intern. Med. 656-657 (August 2002)). Among the most common prescribing errors detected in the hospital were the failure to specify controlled release formulation (69.7%) and prescribing controlled delivery formulations to be administered by tube (11.9%). A study conducted in the United Kingdom found one major London hospital with prescribing errors at a level of about 1.5% of drug orders (Health, Q&A: Hospital Prescribing Errors, Dec. 5, 2002).

In a study reported in the Journal of the American Pharmacists Association (JAPhA) in the March/April 2003 issue, the rate of dispensing errors was estimated by monitoring fifty pharmacies between July 2000 and April 2001 from chain, independent, and health system pharmacies in six large United States cities. The study found a rate of four errors per day in a pharmacy filling 250 prescriptions daily (1.6%), with 77 errors being identified among 4,481 prescriptions (of which errors 6.5% (five) were judged to be clinically significant). The most common error was giving the wrong instructions for use, with several involving dispensing the wrong drug, the wrong strength, or the wrong quantity. A review of four pharmacies in the Glasgow region of the United Kingdom found an internal rate of 50 errors in 5,004 prescriptions (1%), nine of which (0.18% of the total) were considered to be serious with the potential to require significant medical intervention. The study found incorrect labeling accounting for nearly 14 percent of errors (Cox et al., Dealing with Dispensing Errors, The Pharmaceutical Journal 264: 724 (May 2000)). Many of such errors are attributable to illegibly written prescriptions, although selection of drug errors may occur even with legible prescriptions.

Medication prescribing and dispensing errors also occur due to confusingly similar sounding drug names and spellings. For example, U.S. Medication Errors Reporting suggests numerous medication errors because of confusion between Lamictal® (an anticonvulsant) and drugs such as Lamisil® (antifungal) and Lomotil® (anti-diarreheal). Sometimes the error is caused by the prescriber writing the wrong drug name, other times the error is caused by the pharmacist misreading the prescriber's writing. In many instances directions associated with a prescription are too vague for the pharmacist to pick up on the error (e.g., when the sign “As Directed” is indicated on the prescription, and the practice area of the physician is either not indicated or does not lend to an obvious choice between two or more possibilities).

Even when the physician appropriately prescribes a drug for a medical condition with medically-appropriate directions, and the pharmacist correctly dispenses the prescribed drug with the directions specified by the physician, many patients do not demonstrate an optimal therapeutic outcome. For example, many patients will suffer an adverse drug event (ADE) in respect their prescription. It is estimated that adverse drug events (ADEs) result in more than 2.2 million injuries each year. The American Medical Association reports that 100,000 Americans die annually of adverse reactions to prescription drugs. Nearly 4.7% of hospital admissions are due to a serious adverse drug reaction. Other patients may not suffer an adverse drug event, but may fail to find the relief they are seeking. The fact of multiple failures with a particular regimen, while of clinical significance, is typically not picked up in our conventional health care system, because such system is dependent on multiple paper submissions by physicians attending such patients.

Numerous suggestions have been made to improve the medical management of therapeutic treatments.

Many of the suggestions to improve the present paradigm of pharmaceutical dispensing implicate or involve the concept of improving information flow between the pharmacy and others in the health care field, and the patient. For example, U.S. Pat. No. 6,067,524 to Byerly et al. describes a method and system for automatically generating advisory information for pharmacy patients. In such method patient-specific information is appended to a data record containing normally transmitted information at a third party, such as an HMO or PPO, computer and transmitting the data record between the third party computer and a pharmacy computer during a pharmacy transaction. The advisory computer generates an advisory message based on the extracted patient-specific information. U.S. Pat. No. 6,493,427 to Kobylevsky et al. discloses a central station to which a pharmacy can forward verbal or internet calls, such as calls related to refill information. The information obtained is then transferred to the pharmacist such as by periodic faxing, e-mail or through a computer program run on a computer within the pharmacy. In conventional combinatorial synthesis, compounds are conventionally synthesized on plastic beads that are segregated into different containers.

Among the suggestions made to improve the present paradigm of pharmaceutical dispensing, is the electronic prescription. The electronic prescription is seen as improving the flow of information between the physician and pharmacist and reducing the number of medication errors. Indeed, in the House and Senate bills to create an expanded Medicare drug benefit passed on Jun. 27, 2003, the House bill requires physicians to order and transmit all of their prescriptions electronically, while the Senate version required the Department of Health and Human Services to develop and adopt standards to facilitate electronic transmission of drug orders.

The concept of an electronic prescription is described in the art. For example, U.S. Pat. No. 5,992,890 to Simcox describes the use of a hand-held remote computer terminal for data entry of prescription information. The hand-held remote computer includes a means for electronically communicating to a host computer which facilitates verification of data entry and provides for printing and electronic communication with a remote pharmaceutical distribution point. Similarly, U.S. Pat. No. 6,317,719 to Schrier et al. comprises a method for creating electronic prescription comprising selecting a medication, displaying to the user alternative elements for creating an electronic prescription for the selected medication, including the routes associated with the medication, the dosage amounts in which the medication is available in a formulary for a chosen route, the dosage forms in which the medication is available in the formulary for a chosen route that matches the dose amounts, and the frequencies of administration associated with the dosage forms and the chosen route of administration.

Expanding upon the concept of information flow permitted by the electronic transmission of prescriptions, U.S. Pat. No. 5,845,255 discloses a prescription management system which employs wireless electronic prescription creating devices, such as a hand-held computer, which allow a physician to capture into a prescription a patient condition-objective of the prescribed treatment. Such prescription is associated with a patient identifier. The system provides for patient record assembly from source elements, adverse indication review and online access to comprehensive drug information including scientific literature. Remote databases from pharmacies, laboratories and testing facilities may be accessible by such point-of-care devices and information from the devices may be captured in the remote databases. In one embodiment of the invention, an intelligent drug-selection procedure is supported by transparent connectivity to multiple, remote proprietary information systems at the point of care, enabling the physician to draw upon physician-user prescribing-frequency data, patient drug formulary information as to a drug's status with a patient's drug benefits provider, drug dosage characteristics such as form, size and route of administration, drug-specific treatment information as to condition-related related efficacy, and preferably as to contraindications and adverse reactions, relevant patient history information as to current and previous prescriptions and problem-history, and laboratory and diagnostic test information related to the patient's indications. Data may be brought to the point-of-care by relying upon retrieval from remote source databases at remote facilities responsible for capturing original update data.

U.S. Pat. No. 6,112,182 teaches a computer-based pharmaceutical and healthcare practice management system. A computer-based apparatus and process is provided by which a care service and other healthcare related action appropriate for a particular individual or patient is identified, initiated and/or provided through use of a second data process. For example, a user-defined, preprogrammed trigger associated with one or more data items used in connection with a prescription dispensing transaction causes at least one patient care process to be listed in a queue for subsequent review and/or process based on a patient's health state. The care process might, for example, include scheduling an appointment for monitoring lifestyle, health or disease states or conditions, printing information on the dispensed drug, initiating a lifestyle monitoring process designed to improve the health of the patient, recording an intervention, performing patient counseling and performing a subjective/objective assessment and planning protocol in connection with drug therapies. Care processes may also include printing a claim form or submitting a claim to an insurance company, printing coupons, or other information for complementary or alternative drugs and issuing a rebate for the drug.

The electronic prescription has also been suggested as a means for improving the dispensing of drugs to patients. U.S. Pat. Nos. 6,152,364 and 6,352,200 to Schoonen et al. disclose a medicament distribution system and automatic dispenser. A physician enters a prescription for a medicament together with the patient's identity and a prescription signal corresponding to the prescription entered is generated. The control signal is used to dispense the prescribed medicament to the patient by way of an automatic dispenser which may be located remotely from the prescriber. Retrieval of the prescribed medicament may be by way of an identity card possessed by the patient.

Traditional wholesalers of pharmaceutical products have also devised systems for improving health care delivery. For example, McKesson offers clinical software for improved medical management marketed as “CareEnhance Clinical Management Software” and “InterQual Criteria” software, which together assist in making appropriate clinical decisions based on nationally accepted standards of care, and permit storage of information pertaining to disease and therapy utilization in a location accessible to many in the health care chain. Such software is designed to streamline workflow through paperless transfer of information (real-time, online medical management communications) and improve the effectiveness of case management by permitting care managers to proactively create and manage authorization events and referrals, change clinical strategies based on health plans, perform online eligibility and benefits checks, and input on-line medical assessment forms. The system is designed to eliminate the need for manual systems, time-consuming telephone calling, and re-entering of information for faster authorization and streamlined medical reviews. The system employs neural network technology that draws on multi-month pharmacy and medical claim data to identify patients who are at risk of experiencing high healthcare costs. Security features are available to meet HIPAA privacy regulations.

While many suggestions have been provided to improve information flow to allow for more efficient transaction on a prescription or other order, each of these attempts in general depends on the conventional system of distribution of drugs/therapies and provide little in the way of optimizing clinical care based upon data that may be gleaned from the patients themselves. There is therefore the need for a simpler and cheaper system for assuring appropriate clinical management.

### SUMMARY OF INVENTION

The present invention overcomes the disadvantages of the prior art in providing an integrated clinical management system that takes advantage of information generated throughout the management of a disease state or physical malady.

In one embodiment of the present invention, there is provided a clinical management system wherein data collected from individual patients with respect to a treatment protocol outcome is aggregated to provide efficacy adjudication, adverse event profiles, and pharmaco-economic information pertaining to the cost-to-benefit ratio of the treatment protocol. Treatment protocols in such clinical management system may comprise pharmacological and/or non-pharmacological treatments and may be selected by a prescriber from a plurality of treatment options proffered based upon a diagnosis rendered, that may be aided by the input of symptoms and conditions associated with the disease or state which is to be treated. Information concerning individual patients may be gleaned from information provided to the health care professionals interacting with the patients (such as the primary care giver) and may also be provided from remote disease management locations or directly from the patient.

In another embodiment of the present invention, there is provided a system and method for dispensing medications by means of an electronic prescription wherein medication is dispensed from one of a plurality of dispensaries selected based upon the prescription sought, the number of samples provided the patient and the location of the dispensary. A dispensary may also be chosen based upon the cost of the medication and based upon knowledge with respect to the supply of medication at the dispensary. By “dispensary” it is meant any facility permitted by law to dispense therapies, such as medications, pursuant to a prescription or other order. A dispensary facility may include, without limitation, a pharmacy, a wholesaler, a pharmaceutical company, a managed care facility so long as such facility is permitted by law to dispense the therapy to a patient pursuant to an order for such therapy. Selection of the dispensary may be by means of a clinical management station, (e.g., software based or a physical facility) that processes a plurality of therapy orders from a plurality of caregivers. Preferably, the clinical management station handles all insurance adjudications necessary for delivery of the therapy to the patient, including adjudication of the co-pay due to the insurance company and from the insurance company to the care giver. Preferably the clinical management station collects data from a plurality of caregivers and/or patients pertaining to the outcomes of a particular therapy to generate safety, efficacy, adverse event, and/or pharmaco-economic profiles related to the particular therapy, and preferably manages the delivery of refills or reorders of a particular therapy as per the instructions of a caregiver. The clinical management station may further store information useful to particular patients in calculating IRS health care deductions and the like.

In yet another embodiment of the invention, there is provided a system for keeping track of samples provided to the physicians or other caregivers by companies to be dispensed to patients. In this aspect of the invention, the system monitors the physician's inventory of samples, and enables the physician or caregiver to comply with federal laws on dispensing and reporting inventories of samples to the appropriate government agencies. Additionally, the system can arrange to re-order samples from the pharmaceutical companies directly, or from the representatives of the companies, whichever is preferred.

### BRIEF DESCRIPTION OF THE DRAWINGS

The invention claimed and/or described herein is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic of a conventional (prior art) system for the distribution of drugs pursuant to a prescription.

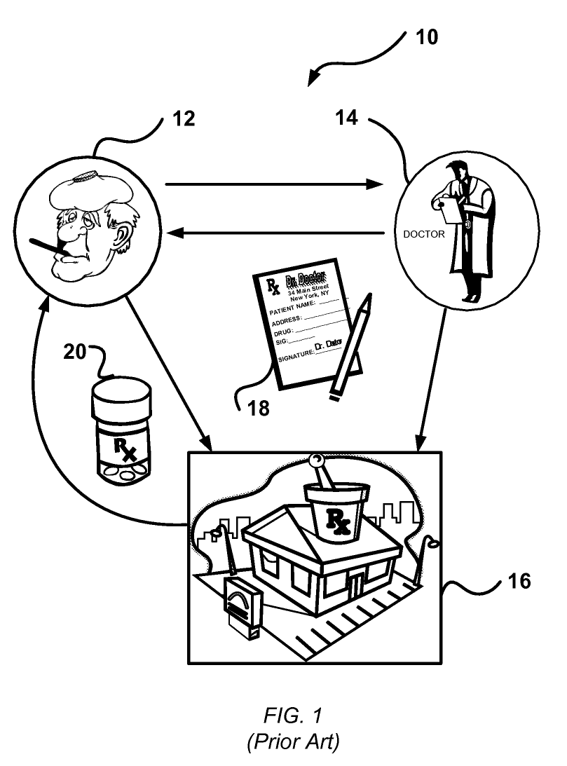

FIG. 2 is a schematic of the an embodiment clinical management system of the present invention an information flow is by electronic means.

FIG. 3 is a flowchart of an embodiment clinical management method of the present invention.

### DETAILED DESCRIPTION

The present invention provides a clinical management system that efficiently obtains clinical data for safety, efficacy and adverse event assessments pertaining to a therapy prescribed for the treatment of a malady, and for the efficient delivery of medications to a patient, which delivery is effected by means of an electronic prescription from a dispensary optimized for delivery of the medication.

An important advantage of the remote, wireless and even handheld data pad-type devices is found in the instantaneous availability of the record of the prescriptions as written by all the various physicians attending the patient's healthcare. This kind of listing can be combined with the simultaneous systematic assessment of potential toxicity, cross-reactivity and mutual exclusivity of the prescribed medication and, if possible, any over-the-counter drugs, together with the subject patient's diagnosis, as well as the patient's physiological and constitutional states. For example, the physiological health assessment can be made on the basis of such wirelessly communicated indicators as temperature, cholesterol level, blood pressure, oxygen tension, liver function, and possibly blood levels of glucose, insulin, and other hormones, drug metabolites, as may be measured by instrumentation directly within the patient's disposal by means of self-service.

In a first embodiment of the present invention, there is provided a clinical management system that entails the processing of outcome digital information pertaining to the outcome of therapies performed on a plurality of patients at a location remote from the plurality of patients. Such system encompasses an automated data processing method for obtaining clinical data for safety, efficacy and adverse event assessments pertaining to a therapy prescribed for the treatment of a malady, the method comprising the steps of: receiving at a location remote from a plurality of patients outcome digital information pertaining to the outcome of therapies performed on the patients; digitally processing the digital outcome information to determine an adverse event profile associated with a particular therapy; digitally processing the outcome information to determine the efficacy of such therapy in the amelioration or cure of the malady treated; and digitally comparing the adverse event profile with the efficacy to determine a safety profile for said particular therapy. The automated data processing method may further comprise steps for assessing the pharmaco-economics of a particular therapy, the steps comprising: obtaining digital data pertaining to the cost of said therapy; and digitally comparing the efficacy of the therapy with said cost of said therapy. A therapy may include a pharmacointervention, for example a treatment with a prescription drug, or may entail a non-drug associated intervention (such as a physical therapy manipulation). Outcome digital data may comprise, without limitation, digital data generated at remote disease management sites. For example, blood pressure readings taken at a health facility may be electronically sent from the health facility, as for example by way of the internet, to the clinical management system. The adverse event profile or therapeutic efficacy determined by such management system may be transmitted to others as permitted by the law, such as a regulatory agency (e.g., FDA) or an insurance company that reimburses the caregiver on the basis of outcome.

In another embodiment of the present invention, there is disclosed a clinical management method in a computer system for the efficient delivery of medications to a patient ordered pursuant to an electronic prescription by a caregiver for such patient, the method comprising the steps of: determining the number of samples provided to the patient of each of the medication(s) prescribed for the patient; determining the treatment-time made possible by the number of samples provided to the patient; determining the amount of medication(s) needed by the patient to complete a therapy round specified in the electronic prescription; determining which of a plurality of dispensaries is optimal for delivery of the medications to the patient based on at least one of: the location of the dispensary, the cost of the medication at each dispensary, or the stock of the medications at each of said dispensaries; and causing the optimal dispensary(ies) to deliver the medication in an amount needed by the patient to complete a therapy round to said patient pursuant to said electronic prescription. The dispensary may be any facility authorized by law to fill the prescription, and may include in respect of location a wholesaler of medications, a pharmaceutical manufacturer, a pharmacy etc. Advantageously, the dispensary may deliver the medication(s) to the patient by mail if such is permitted given the circumstances of the disease state or condition being treated and the number of samples provided the patient. Advantageously, any dispensary may be provided with information pertaining to any refills authorized for the medications specified in the prescription and such refills may be automatically filled and delivered to the patient when the refill is due based on the instructions incorporated in the prescription and/or based on conventional medical practice. In order to reduce paper work, such method may include the steps of (a) contacting the patient's prescription insurance carrier in respect to said prescription; and (b) calculating any co-pay due on filling of medication needed for a therapy round (i.e., the amount of therapy to be dispensed in any dispensing). In one aspect of this embodiment of the invention, the clinical management method system is programmed to monitor the number of samples provided to the physician or caregiver by companies to be dispensed to patients. As the physician or caregiver dispenses the samples, this information is entered into the system. The system then determines the number of samples provided to the patient of each of the medication(s) prescribed for the patient, and the number of samples remaining in the physician's or caregiver's inventory. As the physician's inventory is depleted to a predetermined number of samples, the system automatically reorders samples from the pharmaceutical companies directly, or from the representatives of the companies, whichever is established by the physician or caregiver into the system. Additionally, the system can generate, for example, monthly or annual reports from information gathered on sample dispensation by physician or caregiver to patients for reporting to the appropriate government agencies such as the FDA. Such a report may include information such as the physician dispensing samples, total amount of samples received by the physician from pharmaceutical companies or representatives, the patient receiving samples, number of samples received by the patient and type of sample given to the patient is automatically reported to the appropriate government agencies, such as the FDA.

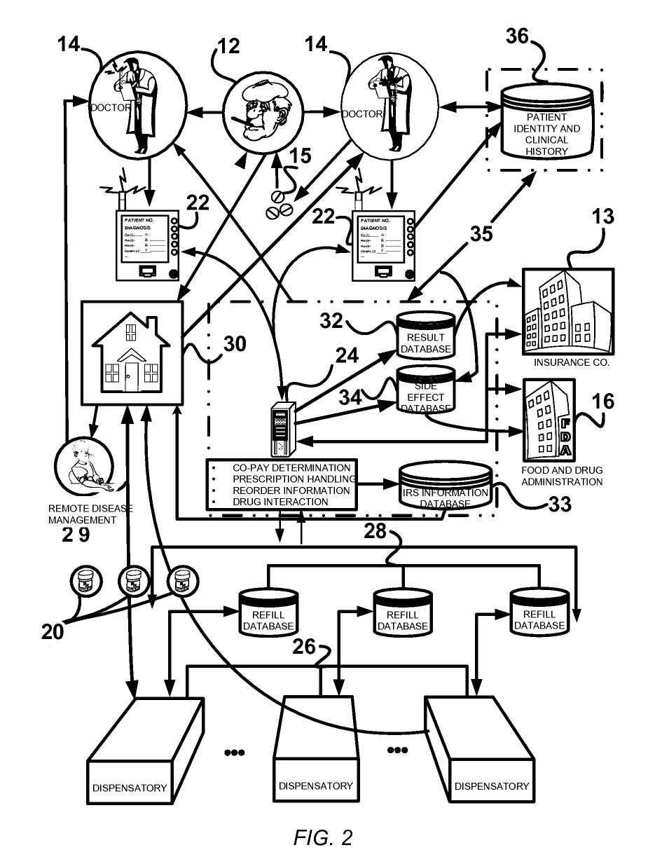

Now turning to the figures, there is shown in FIG. 2 a schematic overview of an exemplar embodiment of the present invention. Patient 12 visits doctor(s) 14 with the complaint of a malady. Doctor(s) 14 may access information pertaining to the patient and the patient's clinical history either from databases stored at the Doctor(s)' office(s) or information associated with clinical management station 35. Doctor(s) 14 may input the patient's diagnosis into a handheld data pad 22 which may be programmed to provide numerous therapeutic interventions that may be used to treat the patient upon such diagnosis input. Such therapeutic interventions may entail the use of prescription drugs, over the counter drugs, or non-drugs (such as physical manipulation or palliative treatments). For example, in the treatment of a cold, the physician may be proffered the choice of treating with an antitussive, an antihistamine-decongestant mixture, intranasal saline solution, an analgesic, a compounded mixture (such as a menthol/camphor mixture) or palliative protocols. Upon choosing one or more interventions, the doctor(s) 14 may determine the number of samples 15 which the doctor wishes to dispense to the patient, and may input the number of samples 15 into data pad 22. Information entered into said data pad(s) 22 includes information pertaining to the identity of patient 12 and optimally includes information pertaining to a mailing address of patient 12. Information entered into data pad(s) 22 which may include relevant clinical information (such as temperature, weight, blood pressure, cholesterol level etc.) and insurance information (e.g., the patient's insurance number) is transmitted in the example of FIG. 2 to clinical management station 35 which comprises a processor which may be physically remote from doctor(s) 14. Clinical management station 35 processes the electronic prescription information, along with other clinical and insurance information inputted with respect to the patient, from data pad(s) 22. Information received is used to complete insurance forms required for payment, to determine whether there are any drug interactions with respect to all drugs to be taken by the patient (regardless of physician who prescribed the drug), and may be used to determine the dispensary(ies) 26 from which the therapy is optimally dispensed to the patient. For example, if the patient has been prescribed high blood pressure medication, and given a three days supply of samples, the dispensary chosen may be the cheapest source of the drug as well as the drug sent by next day mail to the patient's house. On the other hand, if the patient has been prescribed an antibiotic with no samples provided, the dispensary may be a local pharmacy that is located close to the patient's residence 30. Refill information may be stored at the dispensary from which the therapy is dispensed and such dispensary may fill the refill at the appropriate time as indicated on the prescription, or may fill the refill upon receipt of an approval of the same by the patient or the clinical management station 35. Information pertaining to the therapy dispensed and the refills dispensed may be stored in a database 28 for use in filing IRS deductions 33, for example.

Patient 12 of FIG. 2 may provide information to doctor(s) 14 or clinical management station 35 with respect to outcome of the therapeutic intervention. Information pertaining to the outcome of the therapeutic intervention may also be provided from remote disease management sites 29 where objective physical measurements may be taken, for example at a blood pressure machine in a health facility. Such information pertaining to outcome may be stored in a result database 32 associated with clinical management station 35. Such result information may be made accessible as permitted by law to third parties having need of such information, for example an insurance company 13 which may reimburse the doctor based on clinical outcome. Result information may further include information related to side effects suffered, which may be stored in side effect database 34 associated with clinical management station 35. Side effect database 34 may further be used to provide information as permitted by law to third parties having need of such information, such as Food and Drug Administration 16. Such information further will comprise clinical history of the patient 36. Additionally, sample information can be placed into the management station 35 regarding (i) number and type of samples on hand, (ii) number and type of samples dispensed to a given patient; and (iii) pre-set information on appropriate times to contact sample supplier (drug representative and/or drug manufacturer) for re-stocking.

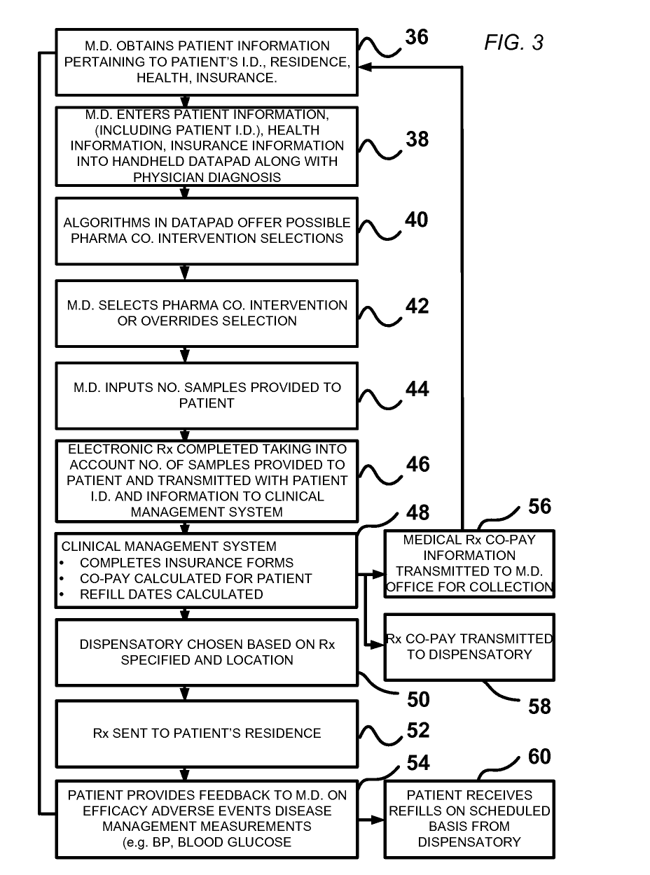

Now turning to FIG. 3, there is shown a flowchart of an embodiment clinical management method of the present invention. At step 36, the physician obtains patient information pertaining to the patient's identification, health, and insurance coverage. Such information is then entered at step 38 into a handheld datapad along with a physician diagnosis, and other clinical information as gleaned from examination of the patient or from the patient. Algorithms at step 40 in the datapad advantageously offer possible pharmacointerventions (and/or other therapies) which are clinically thought to be useful in the treatment of the condition. At step 42, the physician selects the pharmacointervention desired, or overrides the proffered selections. The physician then may provide the patient with samples of any pharmacointervention chosen, inputting at step 44 in the data pad the number of samples provided to the patient. At step 46, an electronic prescription is completed taking into account the number of samples provided to the patient, and such prescription is transmitted with patient identification information to a clinical management system. The clinical management system at step 48 preferably completes the insurance forms necessary for payment from the patient's insurance company, calculates the co-pay for providing the pharmacointervention, at step 58 transmits the Rx co-pay information to the dispensary and/or at step 56 the medical co-pay information to the physician. and calculates refill dates for completion of the therapy. At step 50 a dispensary is chosen for providing the pharmacointervention to the patient, with such selection being based, for example, on the drug selected (e.g. whether the dispensary has the drug in stock, and enough of the drug), the location of the dispensary (e.g. the location of the dispensary might be important if the patient was in immediate need of the drug), and the cost of the drug at the dispensary (e.g. the drug might be provided cheaper through one location versus another). The pharmacointervention, which may be a prescription drug, is then preferably transmitted to the patient's residence at step 52 with refills following on a scheduled basis at step 60. The patient at step 54 may provide feedback to the physician and/or clinical management system on the efficacy and adverse events associated with the therapy and may provide disease management measurements. There might also be built into the system preferred drug manufacturers or suppliers, which could be dictated by the insurance held by the patient or other third parties (e.g., government). Also, there can be built into the system means for inventory tracking of samples, including pre-set information on appropriate times to contact sample supplier for re-stocking, including contact information or contact links (e.g., electronic mail).

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. An automated data processing method for obtaining clinical data for safety, efficacy, and adverse event assessments pertaining to a therapy prescribed for the treatment of a malady, said method comprising the steps of:
receiving at a location remote from a plurality of patients' outcome digital information pertaining to the outcome of therapies performed on said patients;
digitally processing said digital outcome information to determine an adverse event profile associated with a particular therapy;
digitally processing said outcome information to determine the efficacy of such therapy in the amelioration or cure of the malady treated; and
digitally comparing said adverse event profile with said efficacy to determine a safety profile for said particular therapy.

2. The method according to claim 1 optionally including steps for assessing the pharmaco-economics of said therapy, said steps comprising:
obtaining digital data pertaining to the cost of said therapy; and
digitally comparing said efficacy of said therapy with said cost of said therapy.

3. The method of claim 1 wherein said therapy is a pharmacointervention.

4. The method of claim 1 wherein said therapy is a non-drug associated intervention.

5. The method of claim 1 wherein the outcome digital data includes remote disease management data.

6. The method of claim 1 wherein said adverse event profile is transmitted to a regulatory agency responsible for monitoring such adverse events.

7. The method of claim 1 wherein said efficacy data is transmitted to a regulatory agency responsible for monitoring the effectiveness of therapies.

8. The method of claim 1 wherein said efficacy data is transmitted to an insurance company.

9. A clinical management method in a computer system for the efficient delivery of medications to a patient ordered and keeping track of samples pursuant to an electronic prescription by a caregiver for such patient, said method comprising the steps of:
determining the number of samples provided to said patient of each of said medication(s) prescribed for said patient;
determining the treatment-time made possible by the number of samples provided to said patient;
determining the amount of medication(s) needed by said patient to complete a therapy round specified in said electronic prescription;
determining which of a plurality of dispensaries is optimal for delivery of said medications to said patient based on at least one of: the location of said dispensary, the cost of said medication at each dispensary, or the stock of said medications at each of said dispensaries; and
causing said optimal dispensary(ies) to deliver said medication in an amount needed by said patient to complete a therapy round to said patient pursuant to said electronic prescription.

10. The method according to claim 9, wherein at least one of said dispensaries is a wholesaler of medications.

11. The method according to claim 9, wherein at least one of said dispensaries is a pharmaceutical manufacturer.

12. The method according to claim 9, wherein at least one of said dispensaries is a pharmacy.

13. The method according to claim 9 wherein said medications are delivered from to said patient from said dispensary(ies) by mail.

14. The method according to claim 9 wherein any refills for said medications specified in the electronic prescription are automatically filled and delivered to said patient when said refill is due based on the instructions incorporated in said electronic prescription and/or based on conventional medical practice.

15. The method according to claim 9 further comprising the steps of:
contacting the patient's prescription insurance carrier in respect to said prescription; and
calculating any co-pay due on filling of medication needed for a therapy round.
